(19) United States
(12) Patent Application Publication
(10) Pub. No.: US 2015/0355108 A1
(43) Pub. Date: Dec. 10, 2015

(54) INSPECTION SYSTEM AND METHODS OF FABRICATING AND INSPECTING SEMICONDUCTOR DEVICE USING THE SAME

(71) Applicant: SAMSUNG ELECTRONICS CO., LTD., Suwon-si (KR)

(72) Inventors: Jang Ik PARK, Suwon-si (KR); Bong Seok KIM, Seongnam-si (KR); Jung Hoon BYUN, Yongin-si (KR); Kyung Hoon LEE, Gunpo-si (KR); Woo-Young CHOI, Yongin-si (KR)

(73) Assignee: SAMSUNG ELECTRONICS CO., LTD., Suwon-si (KR)

(21) Appl. No.: 14/686,913

(22) Filed: Apr. 15, 2015

(30) Foreign Application Priority Data
Jun. 9, 2014 (KR) 10-2014-0069372

(51) Int. Cl. G01N 21/956; G01N 21/21; G01N 21/88

(52) U.S. Cl. CPC G01N 21/95607; G01N 21/8851; G01N 21/211; G01N 2201/12

(57) ABSTRACT

A method of inspecting a semiconductor device includes measuring an inspection pattern formed on a semiconductor substrate using a measurer configured to measure optical signals reflected from the inspection pattern to obtain a signal expressed by a matrix including spectrum data associated with the inspection pattern, obtaining a first element including a first spectrum from the signal and obtaining a second element including a second spectrum from the signal, obtaining a skew spectrum using a difference between the first and second spectrums, and obtaining an asymmetric signal associated with the inspection pattern using the skew spectrum, the obtaining of the asymmetric signal including obtaining a polarity of the skew spectrum in a wavelength range, and obtaining a numerical value associated with an area of the skew spectrum.

### CROSS-REFERENCE TO RELATED APPLICATION

This U.S. non-provisional patent application claims priority under 35 U.S.C. §119 to Korean Patent Application No. 10-2014-0069372, filed on Jun. 9, 2014, in the Korean Intellectual Property Office, the entire contents of which are hereby incorporated by reference in their entirety.

### BACKGROUND

1. Field

Exemplary embodiments relate to an inspection system and methods of fabricating and inspecting a semiconductor device using the same.

2. Description of the Related Art

Due to their small-sized, multifunctional, and/or low-cost characteristics, semiconductor devices are important elements in the electronic industry. The semiconductor devices may be fabricated using various processes such as photolithography, etching, deposition, ion implantation, and cleaning processes.

An inspection process is performed to examine whether there is any failure in patterns constituting a fabricated semiconductor device. By performing the inspection process, it is possible to optimize a process condition of the fabrication process and determine whether there is any failure in a semiconductor device in an early stage.

As the semiconductor device is scaled down, there is an increasing demand for a method and a system capable of reliably inspecting fine patterns in the semiconductor device.

### SUMMARY

Exemplary embodiments provide a highly-reliable inspection method for a semiconductor device.

Other exemplary embodiments provide an inspection system capable of inspecting a semiconductor device with improved inspection reliability.

Still other exemplary embodiments provide a method of fabricating a highly-reliable semiconductor device.

According to an aspect of an exemplary embodiment, there is provided a method of inspecting a semiconductor device, including measuring an inspection pattern formed on a semiconductor substrate using a measurer configured to measure optical signals reflected from the inspection pattern to obtain a signal expressed by a matrix including spectrum data associated with the inspection pattern, obtaining a first element including a first spectrum from the signal and obtaining a second element including a second spectrum from the signal, obtaining a skew spectrum using a difference between the first and second spectrums, and obtaining an asymmetric signal associated with the inspection pattern using the skew spectrum. The obtaining of the asymmetric signal may include obtaining a polarity of the skew spectrum in a wavelength range, and obtaining a numerical value associated with an area of the skew spectrum.

The measuring of the inspection pattern may include measuring, using the measurer, the inspection pattern at a first azimuth to obtain a first signal, and measuring, using the measurer, the inspection pattern at a second azimuth to obtain a second signal. The first and second azimuths may be selected to have a difference of 180° from each other.

The first element may be obtained from the first signal, and the second element may be obtained from the second signal.

The first and second signals may be respectively expressed by first and second Mueller matrices. The first element may be an element in an i-th row and a j-th column of the first Mueller matrix, and the second element may be an element in the i-th row and the j-th column of the second Mueller matrix, where i and j are integers.

The first element may be an off-diagonal element among off-diagonal elements in the first Mueller matrix, and the second element may be an off-diagonal element among off-diagonal elements in the second Mueller matrix.

The measuring of the inspection pattern may include using a spectroscopic ellipsometer to measure the inspection pattern.

The measuring of the inspection pattern may include measuring the inspection pattern at a single azimuth using the measurer.

The matrix may be expressed as a Mueller matrix. Here, the first element may be an element in an x-th row and a y-th column of the Mueller matrix, and the second element may be an element in the y-th row and the x-th column of the Mueller matrix, where x and y are integers.

Each of the first and second elements may be off-diagonal elements among off-diagonal elements of the Mueller matrix.

The inspection pattern may include a lower pattern and an upper pattern sequentially stacked on the semiconductor substrate, the asymmetric signal may include information on misalignment between the lower and upper patterns, the polarity of the skew spectrum may be obtained to represent a misalignment direction of the upper pattern with respect to the lower pattern, and the numerical value may be obtained to represent a misalignment distance between the upper and lower patterns.

When viewed in a sectional view, the inspection pattern may have a central axis, the asymmetric signal may include information on a tilt of the central axis with respect to a reference line that is normal to a top surface of the semiconductor substrate, the polarity of the skew spectrum may be obtained to represent a tilt direction of the central axis with respect to the reference line, and the numerical value may be obtained to represent a tilt angle of the central axis with respect to the reference line.

The asymmetric signal may include information on misalignment or tilt of the inspection pattern, the polarity of the skew spectrum is obtained to represent a misalignment direction or a tilt direction, the obtaining of the polarity of the skew spectrum may include assigning a first direction for the polarity of the skew spectrum, when the skew spectrum in the wavelength range has a positive value, and assigning a second direction antiparallel to the first direction for the polarity of the skew spectrum, when the skew spectrum in the wavelength range has a negative value, and the first and second directions may be associated with the misalignment direction or the tilt direction.

The asymmetric signal may include information on misalignment or tilt of the inspection pattern, the numerical value may be obtained to represent a misalignment distance or a tilt angle, and the obtaining of the numerical value may include obtaining the area of the skew spectrum, and obtaining the numerical value corresponding to the area of the skew spectrum, based on a correlation function that is prepared in advance to describe a correlation between the area of the skew spectrum and the numerical value associated therewith.

According to another aspect of an exemplary embodiment, there is provided a semiconductor inspection system including signal measurement equipment configured to measure an inspection pattern formed on a semiconductor substrate and obtain a signal expressed by a matrix including spectrum data associated with the inspection pattern, and a controller configured to obtain first and second elements including first and second spectrums, respectively, from the signal, to obtain a skew spectrum using a difference between the first and second spectrums, and to obtain an asymmetric signal associated with the inspection pattern using the skew spectrum. The obtaining of the asymmetric signal may include obtaining a polarity of the skew spectrum in a wavelength range and obtaining a numerical value associated with an area of the skew spectrum.

The signal measurement equipment may include a spectroscopic ellipsometer.

The obtained signal may include a first signal measured at a first azimuth and a second signal measured at a second azimuth, and the first and second azimuths may be selected to have a difference of 180° from each other.

The system may further include a memory device configured to store the first and second signals, the first and second signals may be respectively expressed by first and second Mueller matrices, and the controller may be configured to select elements in an i-th row and a j-th column of the first and second Mueller matrices as the first and second elements, respectively, where i and j are integers.

The first element may be an off-diagonal element among off-diagonal elements in the first Mueller matrix, and the second element may be an off-diagonal element among off-diagonal elements in the second Mueller matrix.

The asymmetric signal may include information on misalignment or tilt of the inspection pattern, the controller may be configured to assign a first direction for the polarity of the skew spectrum, when the skew spectrum in the wavelength range has a positive value, and assign a second direction antiparallel to the first direction for the polarity of the skew spectrum, when the skew spectrum in the wavelength range has a negative value, and the first and second directions may be associated with a misalignment direction or a tilt direction.

According to another aspect of an exemplary embodiment, there is provided a method of fabricating a semiconductor device, including forming an inspection pattern on a semiconductor substrate, loading the semiconductor substrate with the inspection pattern on a stage of signal measurement equipment, measuring the inspection pattern using the signal measurement equipment to obtain a signal expressed by a matrix including spectrum data associated with the inspection pattern, operating a controller connected to the signal measurement equipment to obtain first and second elements including first and second spectrums, respectively, from the signal, to obtain a skew spectrum using a difference between the first and second spectrums, and to obtain an asymmetric signal associated with the inspection pattern using the skew spectrum, unloading the semiconductor substrate with the inspection pattern from the stage of the signal measurement equipment, and generating an alert signal according to whether the asymmetric signal is beyond an allowable range, where the obtaining of the asymmetric signal may include obtaining a polarity of the skew spectrum in a wavelength range and obtaining a numerical value associated with an area of the skew spectrum.

According to another aspect of an exemplary embodiment, there is provided an inspection system including a measurer configured to emit a signal to a pattern formed on a semiconductor substrate and measure the signal reflected from the pattern; and a controller configured to determine a matrix corresponding to the measured signal, obtain a first element and a second element from the matrix, and determine whether the pattern is abnormal based on the first and second elements.

The first element corresponds to a first spectrum, the second element corresponds to a second spectrum, and the controller is configured to determine whether the pattern is abnormal based on a difference between the first and second spectrums.

The difference is proportional to a magnitude of an abnormality in the pattern.

### BRIEF DESCRIPTION OF THE DRAWINGS

Exemplary embodiments will be more clearly understood from the following brief description taken in conjunction with the accompanying drawings. The accompanying drawings represent non-limiting, exemplary embodiments as described herein.

FIG. 1 is a schematic diagram illustrating a semiconductor inspection system according to an exemplary embodiment;

FIG. 2 is a flow chart illustrating a method of inspecting a semiconductor device, according to an exemplary embodiment;

FIG. 3A is a sectional view illustrating first types of reference and inspection patterns, which are contained in a semiconductor device according to an exemplary embodiment;

FIG. 3B is a sectional view illustrating second types of reference and inspection patterns, in a semiconductor device;

FIG. 4 is a schematic diagram illustrating a signal measurement principle used in signal measurement equipment according to an exemplary embodiment;

FIG. 5 is a flow chart illustrating an example of the operation S100 of FIG. 2;

FIGS. 6A and 6B are schematic diagrams provided to illustrate an example of the operation S100 of FIG. 2;

FIG. 7 is a graph schematically showing spectrums of first and second elements obtained in the operation S200 of FIG. 2, according to an exemplary embodiment;

FIG. 8 is a graph schematically showing a skew spectrum obtained in the operation S300 of FIG. 2, according to an exemplary embodiment;

FIG. 9 is a flow chart illustrating an example of the operation S400 of FIG. 2, according to an exemplary embodiment;

FIG. 10 is a graph showing a correlation between an area of skew spectrum and a numerical value of asymmetric signal, according to an exemplary embodiment;

FIGS. 11A and 11B are graphs illustrating skew spectrums depending on asymmetric signals, according to an exemplary embodiment;

FIG. 12 is a schematic diagram illustrating the operation S100 of FIG. 2, according to another exemplary embodiment;

FIG. 13 is a graph schematically showing spectrums of first and second elements obtained in the operation S200 of FIG. 2, according to another exemplary embodiment;

FIGS. 14A and 14B are graphs schematically showing skew spectrums depending on asymmetric signals, according to another exemplary embodiment; and

FIG. 15 is a flow chart illustrating a method of fabricating a semiconductor device using an inspection method according to an exemplary embodiment;

It should be noted that these figures are intended to illustrate the general characteristics of methods, structure and/or materials utilized in certain exemplary embodiments and to supplement the written description provided below. These drawings are not, however, to scale and may not precisely reflect the precise structural or performance characteristics of any given exemplary embodiment, and should not be interpreted as defining or limiting the range of values or properties encompassed by exemplary embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Exemplary embodiments will now be described more fully with reference to the accompanying drawings, in which exemplary embodiments are shown. Exemplary embodiments may, however, be embodied in many different forms and should not be construed as being limited to the exemplary embodiments set forth herein; rather, these exemplary embodiments are provided so that this disclosure will be thorough and complete, and will fully convey the concept of exemplary embodiments to those of ordinary skill in the art. In the drawings, the thicknesses of layers and regions are exaggerated for clarity. Like reference numerals in the drawings denote like elements, and thus, repetitive descriptions thereof will be omitted.

It will be understood that when an element is referred to as being “connected” or “coupled” to another element, the element can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which exemplary embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

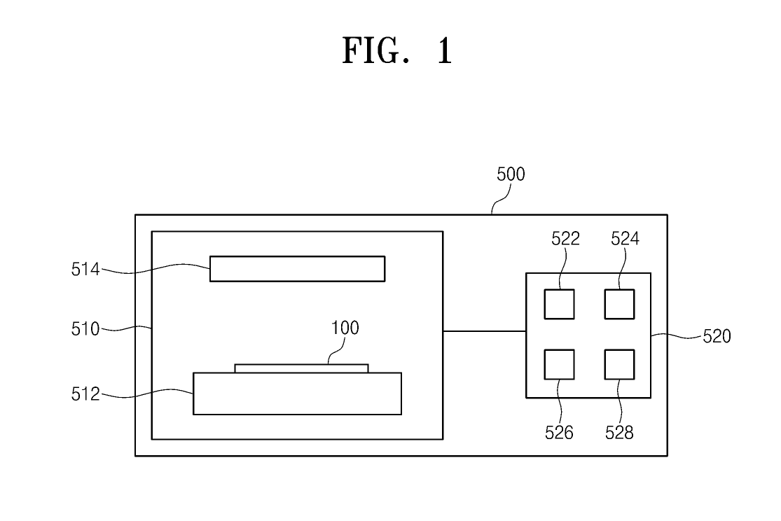

FIG. 1 is a schematic diagram illustrating a semiconductor inspection system according to an exemplary embodiment.

Referring to FIG. 1, according to an exemplary embodiment, a semiconductor inspection system 500 may include signal measurement equipment 510 and a computer system 520. The signal measurement equipment 510 may include a stage 512, on which a semiconductor substrate 100 is loaded, and a measurement unit 514 (e.g., measurer) for measuring optical signals originated from (e.g., reflected by) patterns formed on the semiconductor substrate 100. The optical signals may include spectrum data from the patterns. The signal measurement equipment 510 may be configured to perform a non-destructive test on the patterns. The signal measurement equipment 510 may be, for example, a spectroscopic ellipsometer.

The computer system 520 may be configured to process the optical signals obtained from the signal measurement equipment 510. The computer system 520 may include a controller 522 for processing data and a memory device 524 for storing data. The memory device 524 may include a non-volatile data-storage medium. For example, the memory device 524 may include a hard disk drive and/or a non-volatile semiconductor memory device (such as FLASH memory devices, phase-changeable memory devices, and/or magnetic memory devices). The functions of the controller 522 and the memory device 524 will be described in more detail below. In addition, the computer system 520 may further include an input/output unit 526 (e.g., inputter/outputter) and an interface unit 528 (e.g., interface). The input/output unit 526 may include at least one of a keyboard, a keypad, and/or a display device. Data obtained by the signal measurement equipment 510 may be transmitted to the computer system 520 via the interface unit 528. Further, data processed in the computer system 520 may be transmitted to the signal measurement equipment 510 via the interface unit 528. The interface unit 528 may include a wired element, a wireless element, a universal serial bus (USB) port, and so forth. The controller 522, the memory device 524, the input/output unit 526, and the interface unit 528 may be coupled to each other via at least one data bus.

The semiconductor inspection system 500 may be used for an inspection process of a semiconductor device. An example of the inspection process will be described below.

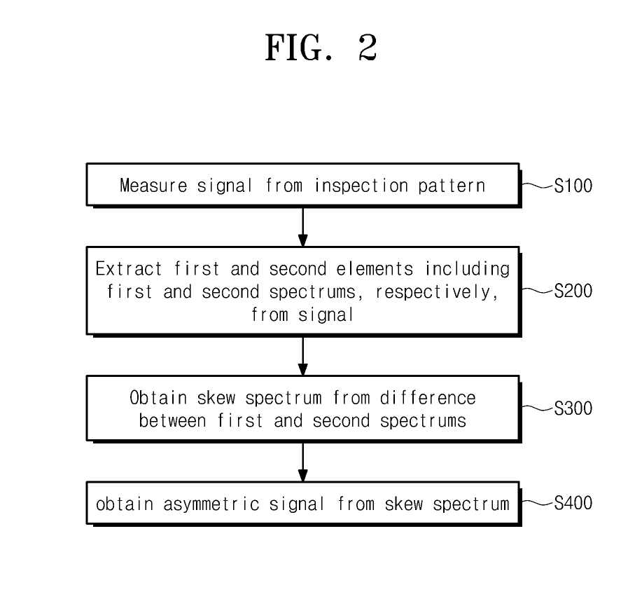

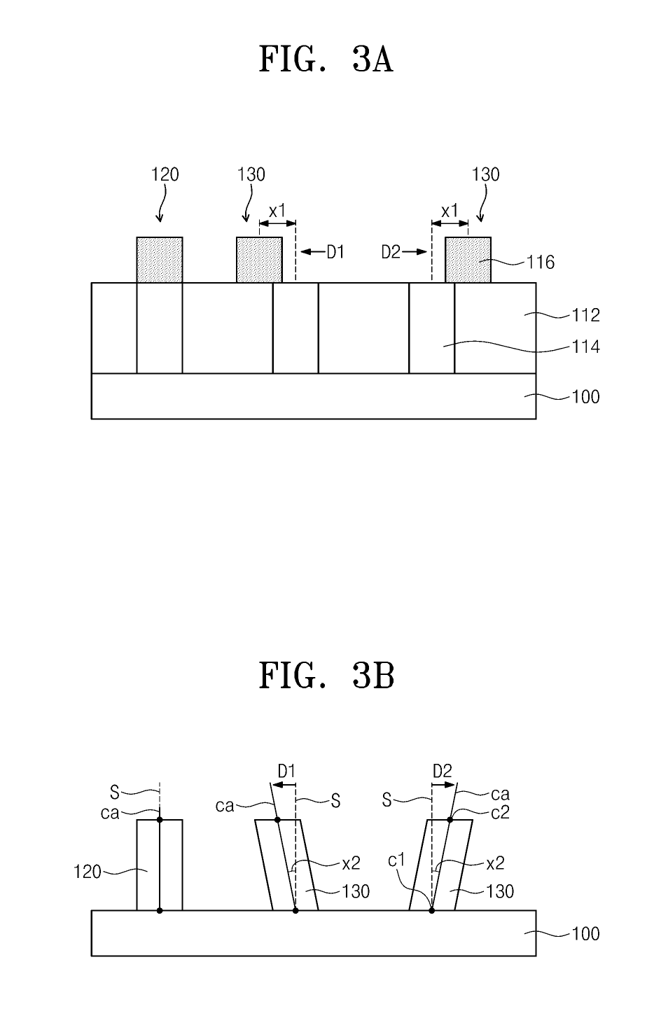

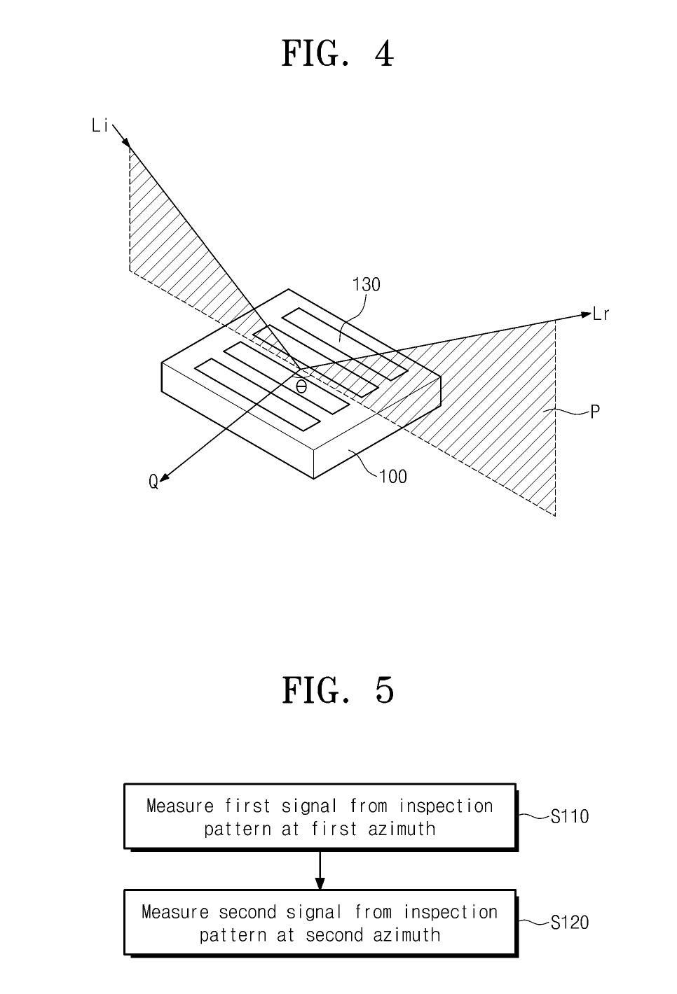

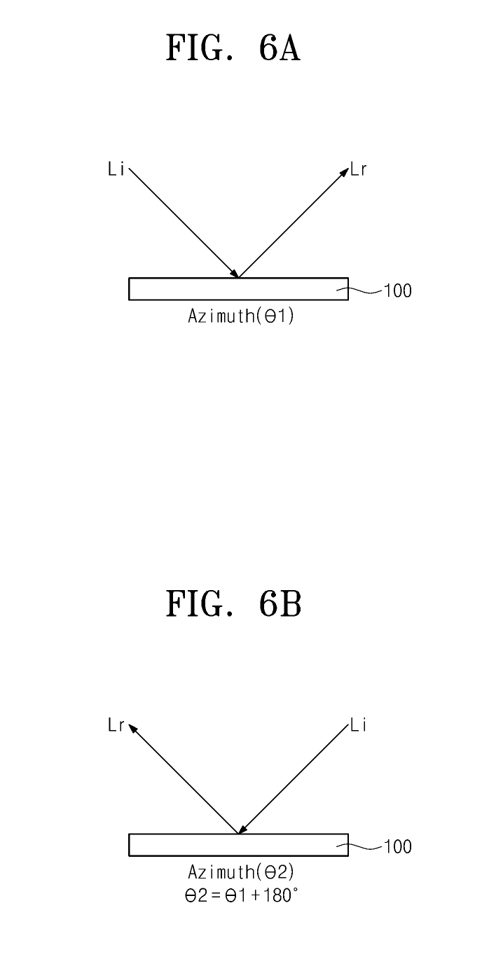

FIG. 2 is a flow chart illustrating a method of inspecting a semiconductor device, according to an exemplary embodiment. FIG. 3A is a sectional view illustrating first types of reference and inspection patterns, which are contained in a semiconductor device according to an exemplary embodiment, and FIG. 3B is a sectional view illustrating second types of reference and inspection patterns, in a semiconductor device, according to an exemplary embodiment. FIG. 4 is a schematic diagram illustrating a signal measurement principle used in signal measurement equipment according to an exemplary embodiment, and FIG. 5 is a flow chart illustrating an example of the operation S100 of FIG. 2. FIGS. 6A and 6B are schematic diagrams provided to illustrate an example of the operation S100 of FIG. 2.

Referring to FIGS. 2, 3A, and 3B, signals may be measured from an inspection pattern 130 in operation S100. The inspection pattern 130 may be provided on the semiconductor substrate 100. The inspection pattern 130 may constitute a part of the semiconductor device. In some cases, the inspection pattern 130 may have an abnormal shape. For example, the inspection pattern 130 may be a pattern among patterns that cannot perform their intended respective functions (for example, for electric connection) normally. In other words, the inspection pattern 130 may correspond to one of various types of failure patterns of the semiconductor device. A first type of the inspection pattern 130 may include a lower pattern 114 and an upper pattern 116 that are sequentially stacked on the semiconductor substrate 100, as shown in FIG. 3A. For example, an insulating layer 112 may be provided on the semiconductor substrate 100, and the lower pattern 114 may be provided in the insulating layer 112. The upper pattern 116 may be provided on the lower pattern 114. The first type of the inspection pattern 130 may include the lower and upper patterns 114 and 116 that are misaligned with respect to each other. For example, the upper pattern 116 may be misaligned with respect to the lower pattern 114 in a first direction D1 or in a second direction D2, which may be antiparallel to the first direction D1. In this case, a misalignment distance between the upper and lower patterns 116 and 114 may be represented by a misalignment value x1, and an absolute value of x1 may be greater than zero (i.e., |x1|>0). A second type of the inspection pattern 130 may have a central axis ca, when viewed in a sectional view. The central axis ca may be a straight line going through centers c1 and c2 of bottom and top surfaces of the pattern. The central axis ca of the second type of the inspection pattern 130 may not be parallel to a reference line S that is normal to a top surface of the semiconductor substrate 100, as shown in FIG. 3B. For example, the central axis ca may be slanted from the reference line S toward the first direction D1 or toward the second direction D2. In this case, an angle between the central axis ca and the reference line S may be represented by a tilt value x2, and an absolute value of x2 may be greater than zero (i.e., |x2|>0).

The semiconductor substrate 100 may be a wafer including a plurality of chip regions. If a fabrication process is finished, each of the chip regions may be used as the semiconductor device. A plurality of patterns may be formed on each of the chip regions, and at least one of the patterns may correspond to the inspection pattern 130.

A reference pattern 120 may be formed on the semiconductor substrate 100. The reference pattern 120 may be used as a part of the semiconductor device. The reference pattern 120 may have a normal shape. For example, the reference pattern 120 may be a pattern among patterns that can perform their intended respective functions normally. A first type of the reference pattern 120 may include the lower pattern 114 and the upper pattern 116 sequentially stacked on the semiconductor substrate 100, as shown in FIG. 3A. The first type of the reference pattern 120 may include the lower and upper patterns 114 and 116 that are aligned with each other. In this case, the misalignment value x1 may be zero (i.e., x1=0). A second type of the reference pattern 120 may have a central axis ca, when viewed in a sectional view. The central axis ca of the second type of the reference pattern 120 may be positioned to be coincident with or parallel to the reference line S, as shown in FIG. 3B. In this case, the tilt value x2 may be zero (i.e., x2=0).

Thereafter, the signal measurement equipment 510 described with reference to FIG. 1 may be used to measure the signal from the inspection pattern 130.

Referring to FIG. 4, a plurality of inspection patterns 130 may be arranged along a specific direction Q on the semiconductor substrate 100. An incident beam Li emitted from the measurement unit 514 may be irradiated onto the semiconductor substrate 100 with the inspection pattern 130. In this case, an incidence plane P may be at an angle of θ with respect to the specific direction Q. Hereinafter, the angle θ may also be referred to as an azimuth. The azimuth θ may be selected to optimally measure the signal from the inspection pattern 130. In other words, the azimuth θ may be changed depending on a structure of the inspection pattern 130. The incident beam Li may be diffracted and reflected by the inspection pattern 130, and the measurement unit 514 may analyze a reflected beam Lr to obtain signal data. The signal data may include spectrum data associated with the inspection pattern 130.

Referring to FIGS. 5, 6A, and 6B, according to an exemplary embodiment, the measuring of the signal from the inspection pattern 130 may include measuring a first signal from the inspection pattern 130 at a first azimuth θ1 (in operation S110) and measuring a second signal from the inspection pattern 130 at a second azimuth θ2 in operation S120. The second azimuth θ2 may be expressed by the following equation 1:

θ2=θ1+180° Equation 1

For example, the semiconductor substrate 100 with the inspection pattern 130 may be provided on the stage 512 of the signal measurement equipment 510. Thereafter, as shown in FIG. 6A, an incident beam Li may be incident onto the semiconductor substrate 100 at the first azimuth θ1. The incident beam Li may be diffracted and reflected by the inspection pattern 130, and the measurement unit 514 may analyze the reflected beam Lr reflected from the inspection pattern 130 to obtain the first signal data. As expressed in the following equation 2, the first signal may be represented by a first Mueller matrix M1:

$$\begin{matrix}Equation 2 & \\ M 1 = ↵ ( \begin{matrix} & {M}_{13} & {M}_{14} ↵ \\ & {M}_{23} & {M}_{24} ↵ \\ & {M}_{33} & {M}_{34} ↵ \\ & {M}_{43} & {M}_{44} ↵\end{matrix} ) & Azimuth θ1↵\end{matrix}$$

where Mij denotes an element in the i-th row and j-th column of the first Mueller matrix M1, and i and j are integers. Each element in the first Mueller matrix M1 may be expressed by or associated with a spectrum. It is understood that other types of matrices may be used.

Next, as shown in FIG. 6B, an incident beam Li may be incident onto the semiconductor substrate 100 at the second azimuth θ2. The incident beam Li may be diffracted and reflected by the inspection pattern 130, and the measurement unit 514 may analyze the reflected beam Lr reflected from the inspection pattern 130 to obtain the second signal data. As expressed in the following equation 3, the second signal may be represented by a second Mueller matrix M2:

$$\begin{matrix}Equation 3 & \\ M 2 = ↵ ( \begin{matrix} & {M}_{13} & {M}_{14} ↵ \\ & {M}_{23} & {M}_{24} ↵ \\ & {M}_{33} & {M}_{34} ↵ \\ & {M}_{43} & {M}_{44} ↵\end{matrix} ) & Azimuth θ2↵\end{matrix}$$

where Mnm denotes an element in the n-th row and m-th column of the second Mueller matrix M2, and n and m are integers. Each element in the second Mueller matrix M2 may be expressed by or associated with a spectrum.

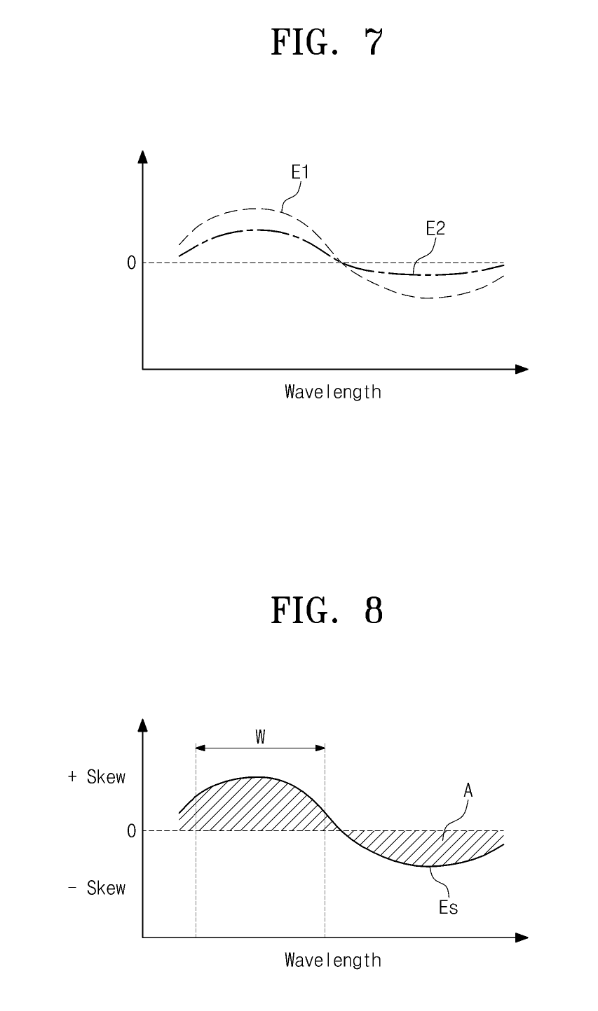

FIG. 7 is a graph schematically showing spectrums of first and second elements obtained in the operation S200 of FIG. 2, according to an exemplary embodiment.

Referring to FIGS. 1, 2, and 7, the measured signal data may be stored in the memory device 524 of the computer system 520. Thereafter, the controller 522 may be operated to extract first and second elements from the measured signal data in operation S200. According to an exemplary embodiment, the first element may be obtained from the first signal data, and the second element may be obtained from the second signal data. The first element may be an element Mij in the i-th row and j-th column of the first Mueller matrix M1, and the second element may be an element Mnm in the n-th row and m-th column of the second Mueller matrix M2. According to an exemplary embodiment, the row indices i and n may be the same, and the column indices j and m may be the same. In other words, the first and second elements may be two elements in the same position of the first and second Mueller matrices M1 and M2.

According to an exemplary embodiment, the first element may be one of the off-diagonal elements (for example, including M13, M14, M23, M24, M31, M32, M41, and M42) of the first Mueller matrix M1, and the second element may be one of the off-diagonal elements (for example, including M13, M14, M23, M24, M31, M32, M41, and M42) of the second Mueller matrix M2. As an example, the first element may be the element M23 of the first Mueller matrix M1, and the second element may be the element M23 of the second Mueller matrix M2. As shown in FIG. 7, the first element may be expressed by or associated with a first spectrum E1, and the second element may be expressed by or associated with a second spectrum E2. In the case where the first and second elements are measured from the reference pattern 120 of FIGS. 3A and 3B, the first and second spectrums E1 and E2 may be substantially the same. By contrast, in the case where the first and second elements are measured from the inspection pattern 130 of FIGS. 3A and 3B, the first and second spectrums E1 and E2 may be different from each other.

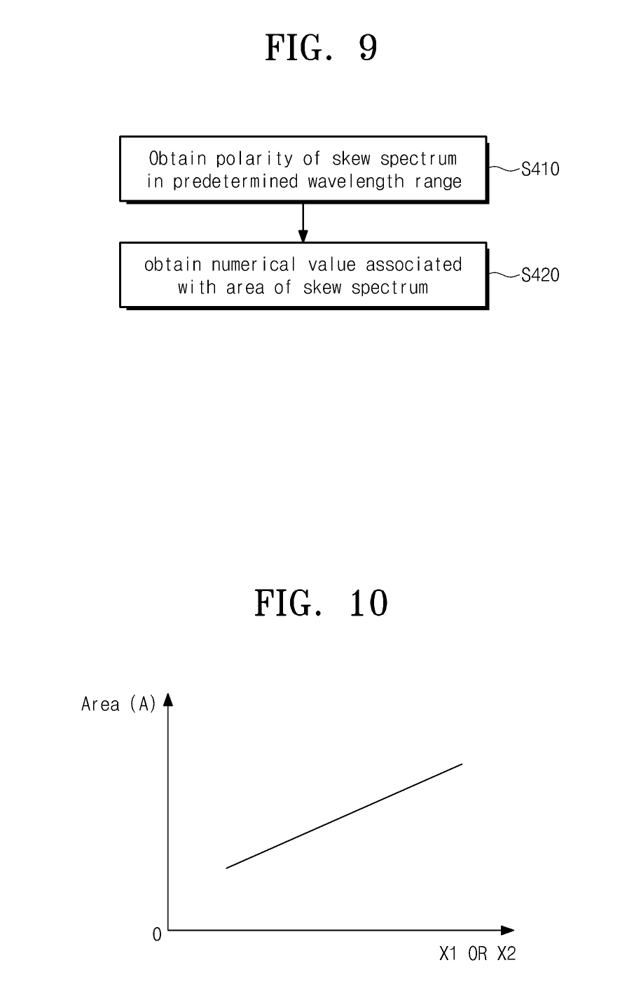

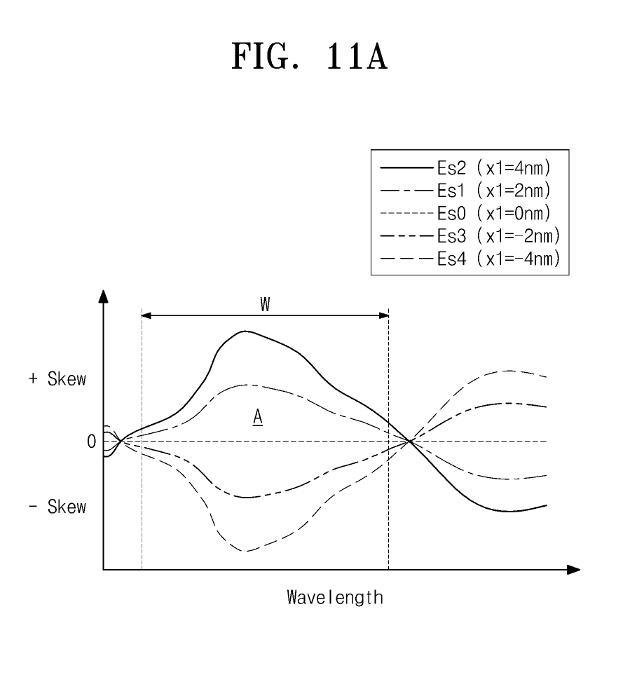

FIG. 8 is a graph schematically showing a skew spectrum obtained in the operation S300 of FIG. 2, according to an exemplary embodiment, and FIG. 9 is a flow chart illustrating an example of the operation S400 of FIG. 2, according to an exemplary embodiment. FIG. 10 is a graph showing a correlation between an area of skew spectrum and a numerical value of an asymmetric signal, according to an exemplary embodiment.

Referring to FIGS. 1, 2, and 8, a skew spectrum Es may be obtained from a difference between the first and second spectrums E1 and E2 in operation S300. The skew spectrum Es may be obtained by operating the controller 522. The skew spectrum Es may be calculated by the following equation 4:

Es=E1−E2 Equation 4

The skew spectrum Es may be stored in the memory device 524.

Next, referring to FIGS. 1, 2, 8, and 9, the skew spectrum Es may be used to obtain an asymmetric signal associated with the inspection pattern 130 in operation S400. The asymmetric signal may include information indicating a misalignment between the lower and upper patterns 114 and 116 included in the inspection pattern 130 described with reference to FIG. 3A or may include information indicating a tilt of the central axis ca of the inspection pattern 130 with respect to the reference line S described with reference to FIG. 3B. The asymmetric signal may be obtained by operating the controller 512.

The asymmetric signal may be described in terms of polarity and value. For example, the obtaining of the asymmetric signal may include obtaining a polarity of the skew spectrum Es in a predetermined wavelength range W in operation S410, and then obtaining a numerical value associated with an area A of the skew spectrum Es in operation S420. The polarity of the skew spectrum Es may represent a misalignment direction of the upper pattern 116 with respect to the lower pattern 114 or a tilt direction of the central axis ca with respect to the reference line S. The numerical value of the skew spectrum Es may be given by a misalignment distance x1 of the upper pattern 116 with respect to the lower pattern 114 or a tilt angle x2 of the central axis ca with respect to the reference line S.

For example, in the case where the skew spectrum Es has a positive value (e.g., + skew) in the predetermined wavelength range W, the asymmetric signal may indicate the first direction D1. In other words, in the case where the skew spectrum Es has the positive value in the predetermined wavelength range W, the upper pattern 116 may be misaligned from the lower pattern 114 in the first direction D1 or the central axis ca may be slanted toward the first direction D1 with respect to the reference line S, as shown in FIGS. 3A and 3B. In the case where the skew spectrum Es has a negative value (e.g., − skew) in the predetermined wavelength range W, the asymmetric signal may indicate the second direction D2. In other words, in the case where the skew spectrum Es has the negative value in the predetermined wavelength range W, the upper pattern 116 may be misaligned from the lower pattern 114 in the second direction D2 or the central axis ca may be slanted toward the second direction D2 with respect to the reference line S, as shown in FIGS. 3A and 3B. According to an exemplary embodiment, the predetermined wavelength range may be about 300 nm-600 nm.

A correlation function may be prepared to describe the correlation between the area A of the skew spectrum Es and the numerical value associated therewith. According to an exemplary embodiment, the correlation function may be obtained in an empirical manner, and the numerical value of the asymmetric signal may be obtained from the correlation function. As shown in FIG. 10, the numerical value x1 or x2 of the asymmetric signal may be in linear correlation with the area A of the skew spectrum Es. For example, the misalignment distance x1 or the tilt angle x2 may increase as the area A increases.

The obtaining the numerical value x1 or x2 of the asymmetric signal may include obtaining the area A of the skew spectrum Es from data obtained in the operation S300 of FIG. 2 using the controller 522, and then substituting the obtained area A into the prepared correlation function to obtain the misalignment distance x1 or the tilt angle x2.

Referring back to FIGS. 1 and 2, the asymmetric signal obtained from the skew spectrum Es may be stored in the memory device 524 and may be displayed to the outside by the input/output unit 526.

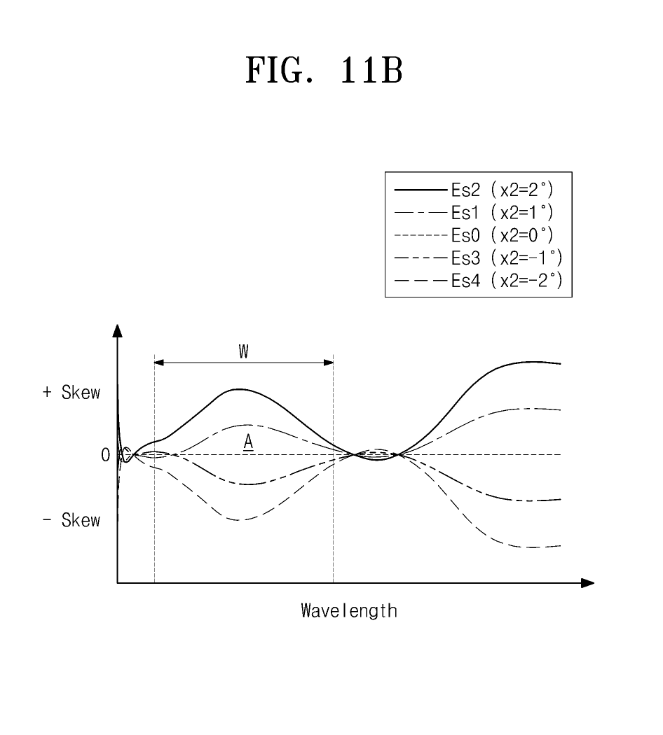

FIGS. 11A and 11B are graphs illustrating skew spectrums depending on asymmetric signals, according to an exemplary embodiment. In detail, FIG. 11A illustrate skew spectrums Es resulting from misalignment between the upper and lower patterns 116 and 114 of FIG. 3A. Referring to FIGS. 3A and 11A, in the case where the upper and lower patterns 116 and 114 are normally aligned with each other (e.g., x1=0), the skew spectrum Es may be zero (as shown by a dotted line Es0). In other words, the skew spectrum Es of the first type of the reference pattern 120 may be zero. In the case where the upper pattern 116 is misaligned from the lower pattern 114 in the first direction D1 (for example, to have the misalignment distance x1 of 2 nm and 4 nm), the skew spectrum Es may have positive values in the predetermined wavelength range W (as shown by curves Es1 and Es2). By contrast, in the case where the upper pattern 116 is misaligned from the lower pattern 114 in the second direction D2 (for example, to have the misalignment distance x1 of −2 nm and −4 nm), the skew spectrum Es may have negative values in the predetermined wavelength range W (as shown by curves Es3 and Es4). As an absolute value of the misalignment distance x1 increases, the area A of the skew spectrum Es may increase.

FIG. 11B illustrate skew spectrums Es resulting from a tilt of the patterns shown in FIG. 3B. In the case where the central axis ca is positioned to be coincident with or parallel to the reference line S (e.g., x2=0), the skew spectrum Es may be zero (as shown by a dotted line of Es0=0). In other words, the skew spectrum Es of the second type of the reference pattern 120 may be zero. In the case where the central axis ca is slanted toward the first direction D1 with respect to the reference line S (for example, to have the tilt angle x2 of 1° or 2°), the skew spectrum Es may have positive values in the predetermined wavelength range W (as shown by curves Es1 and Es2). By contrast, in the case where the central axis ca is slanted toward the second direction D2 with respect to the reference line S (for example, to have the tilt angle x2 of −1° or −2°, the skew spectrum Es may have negative values in the predetermined wavelength range W (as shown by curves Es3 and Es4). As an absolute value of the tilt angle x2 between the central axis ca and the reference line S increases, the area A of the skew spectrum Es may increase.

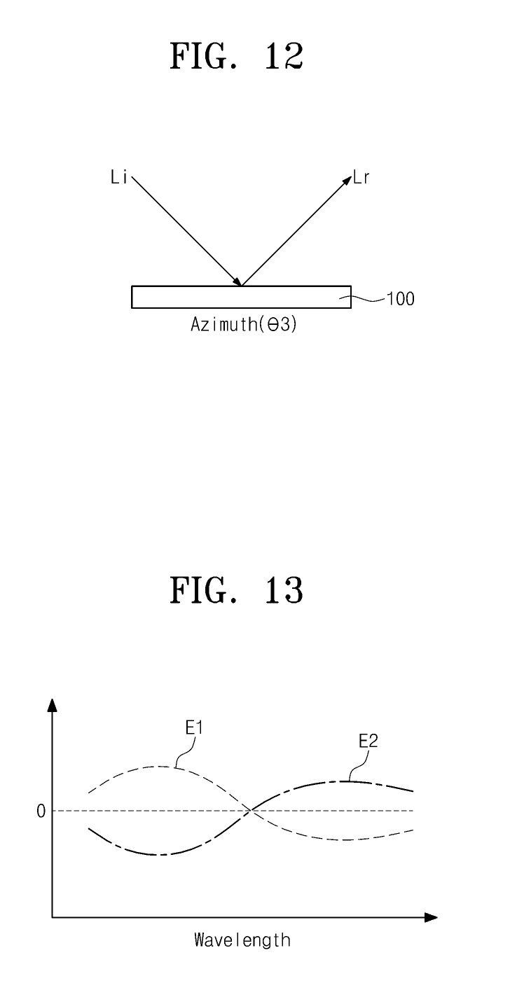

FIG. 12 is a schematic diagram illustrating the operation S100 of FIG. 2, according to another exemplary embodiment, and FIG. 13 is a graph schematically showing spectrums of first and second elements obtained in the operation S200 of FIG. 2, according to another exemplary embodiments.

Referring to FIGS. 2, 3A, 3B, and 12, the signal measurement equipment 510 described with reference to FIG. 1 may be used to measure signals reflected from the inspection pattern 130 in operation S100. According to the present exemplary embodiment, the measuring of the signals from the inspection pattern 130 may include measuring the signals reflected from the inspection pattern 130 at the specific azimuth θ3. In other words, the measuring of the signal from the inspection pattern 130 may be performed at a single azimuth. The specific azimuth θ3 may be selected to optimally measure the signals from the inspection pattern 130.

For example, the semiconductor substrate 100 with the inspection pattern 130 may be provided on the stage 512 of the signal measurement equipment 510. Thereafter, as shown in FIG. 12, the incident beam Li may be incident onto the semiconductor substrate 100 at the specific azimuth θ3. The incident beam Li may be diffracted and reflected by the inspection pattern 130, and in this case, the measurement unit 514 may analyze a reflected beam Lr to obtain signal data associated with the inspection pattern 130. As expressed in the following equation 5, the signal data may be represented by a third Mueller matrix M3:

$$\begin{matrix}Equation 5 & \\ M 3 = ↵ ( \begin{matrix} & {M}_{13} & {M}_{14} ↵ \\ & {M}_{23} & {M}_{24} ↵ \\ & {M}_{33} & {M}_{34} ↵ \\ & {M}_{43} & {M}_{44} ↵\end{matrix} ) & Azimuth θ3↵\end{matrix}$$

where Mxy denotes an element in the x-th row and y-th column of the third Mueller matrix M3, and x and y are integers. Each element in the third Mueller matrix M3 may be expressed by or associated with a spectrum.

Referring to FIGS. 1, 2, and 13, the measured signal data may be stored in the memory device 524 of the computer system 520. Thereafter, the controller 522 may be operated to extract first and second elements from the measured signal data in operation S200. According to the present exemplary embodiment, the second element may be an element of the third Mueller matrix M3 having row and column indices which are given by exchanging row and column indices of the first element. In other words, if the first element is an element in the x-th row and y-th column of the third Mueller matrix M3, the second element may be another element in the y-th row and x-th column of the third Mueller matrix M3.

According to an exemplary embodiment, each of the first and second elements may be one of the off-diagonal elements (for example, elements including M13, M14, M23, M24, M31, M32, M41, and M42) of the third Mueller matrix M3. As an example, the first element may be the element M23 of the third Mueller matrix M3, and the second element may be the element M32 of the third Mueller matrix M3. As shown in FIG. 13, the first element may be expressed by or associated with a first spectrum E1, and the second element may be expressed by or associated with a second spectrum E2. In the case where the first and second elements are measured from the reference pattern 120 of FIGS. 3A and 3B, the first and second spectrums E1 and E2 may be substantially symmetric with respect to each other. By contrast, in the case where the first and second elements are measured from the inspection pattern 130 of FIGS. 3A and 3B, the first and second spectrums E1 and E2 may not be symmetric with respect to each other.

Referring back to FIGS. 1, 2, and 8, a skew spectrum Es may be obtained from a difference between the first and second spectrums E1 and E2 in operation S300. The skew spectrum Es may be obtained by operating the controller 522. According to an exemplary embodiment, the skew spectrum Es may be obtained using the equation 4.

Further, referring back to FIGS. 1, 2, 8, and 9, the skew spectrum Es may be used to obtain an asymmetric signal associated with the inspection pattern 130 in operation S400. The asymmetric signal may be described in terms of polarity and value. For example, the obtaining of the asymmetric signal may include obtaining a polarity of the skew spectrum Es in a predetermined wavelength range W in operation S410, and then obtaining a numerical value associated with an area A of the skew spectrum Es in operation S420. According to an exemplary embodiment, the asymmetric signal may be obtained using the same method as the method described with reference to FIGS. 1, 2, and 8 through 10.

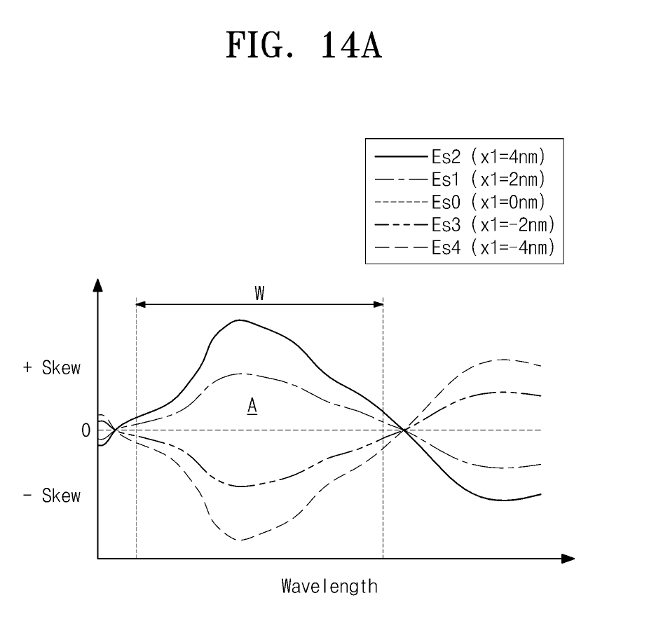

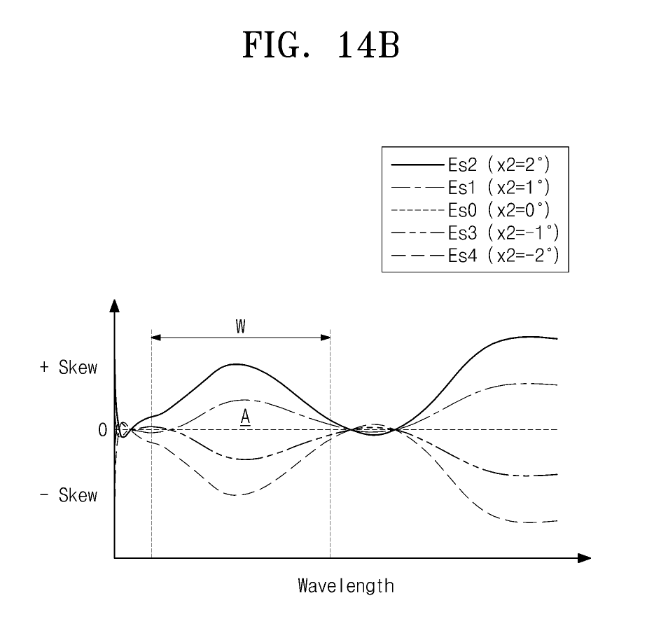

FIGS. 14A and 14B are graphs schematically showing skew spectrums depending on asymmetric signals, according to another exemplary embodiment. In detail, FIG. 14A illustrates skew spectrums Es resulting from misalignment between the upper and lower patterns 116 and 114 of FIG. 3A. Referring to FIGS. 3A and 14A, in the case where the upper and lower patterns 116 and 114 are normally aligned with each other (e.g., x1=0), the skew spectrum Es may be zero (as shown by a dotted line Es0). In other words, the skew spectrum Es of the first type of the reference pattern 120 may be zero. In the case where the upper pattern 116 is misaligned from the lower pattern 114 in the first direction D1 (for example, to have the misalignment distances x1 of 2 nm and 4 nm), the skew spectrum Es may have positive values in the predetermined wavelength range W (as shown by curves Es1 and Es2). By contrast, in the case where the upper pattern 116 is misaligned from the lower pattern 114 in the second direction D2 (for example, to have the misalignment distances x1 of −2 nm and −4 nm), the skew spectrum Es may have negative values in the predetermined wavelength range W (as shown by curves Es3 and Es4). As an absolute value of the misalignment distance x1 increases, the area A of the skew spectrum Es may increase.

FIG. 14B illustrate skew spectrums Es resulting from a tilt of the pattern shown in FIG. 3B. In the case where the central axis ca is positioned to be coincident with or parallel to the reference line S (e.g., x2=0), the skew spectrum Es may be zero (as shown by a dotted line of Es0=0). In other words, the skew spectrum Es of the second type of the reference pattern 120 may be zero. In the case where the central axis ca is slanted toward the first direction D1 with respect to the reference line S (for example, to have the tilt angle x2 of 1° or 2°), the skew spectrum Es may have positive values in the predetermined wavelength range W (as shown by curves Es1 and Es2). By contrast, in the case where the central axis ca is slanted toward the second direction D2 with respect to the reference line S (for example, to have the tilt angle x2 of −1° or −2°, the skew spectrum Es may have negative values in the predetermined wavelength range W (as shown by curves Es3 and Es4). As an absolute value of the tilt angle x2 between the central axis ca and the reference line S increases, the area A of the skew spectrum Es may increase.

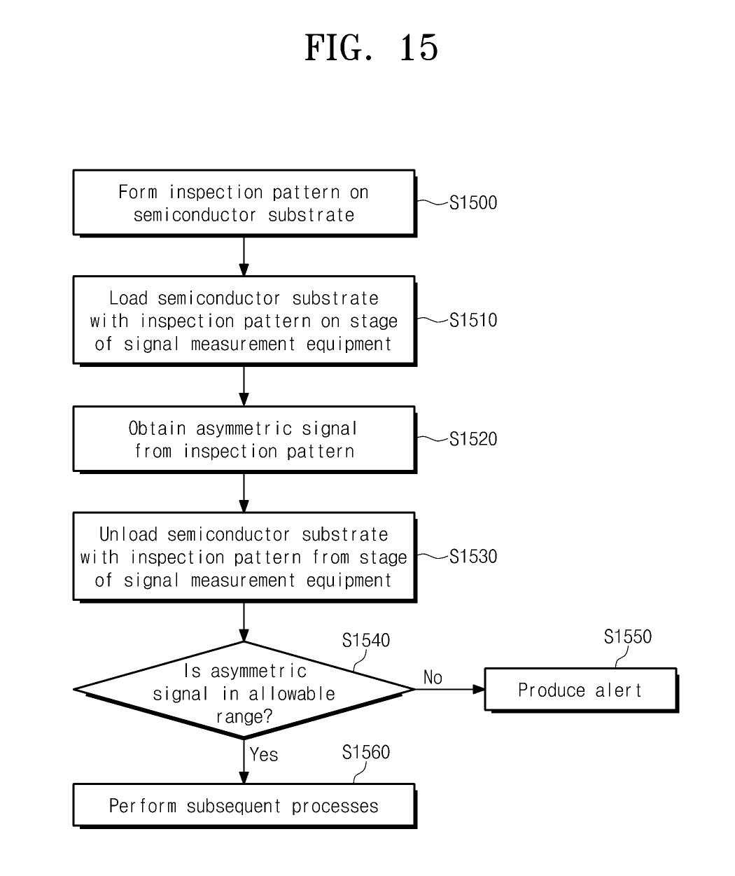

FIG. 15 is a flow chart illustrating a method of fabricating a semiconductor device using an inspection method according to an exemplary embodiment.

Referring to FIG. 1 and FIG. 15, as described with reference to FIGS. 3A and 3B, the inspection pattern 130 may be formed on the semiconductor substrate 100 in operation S1500. The semiconductor substrate 100 with the inspection pattern 130 may be loaded on the stage 512 of the signal measurement equipment 510 in operation S1510. An asymmetric signal may be obtained from the inspection pattern 130 using the measurement unit 514 of the signal measurement equipment 510 and the computer system 520 in operation S1520. According to an exemplary embodiment, the asymmetric signal may be obtained by the inspection method described with reference to FIG. 2. Next, the semiconductor substrate 100 with the inspection pattern 130 may be unloaded from the stage 512 in operation S1530. Thereafter, an analysis step may be performed to determine whether the asymmetric signal is in an allowable range in operation S1540. If the asymmetric signal is in an allowable range, subsequent processes for fabricating a semiconductor device may be performed on the semiconductor substrate 100 in operation S1560. If the asymmetric signal is not in the allowable range, an alert may be sent to an operator in operation S1550.

According to exemplary embodiments, the inspection pattern 130 may be included in a semiconductor device, and may be formed on the chip region of the semiconductor substrate 100. Signals or spectrum data may be measured or obtained from the inspection pattern 130, and the first and second elements may be extracted from a Mueller matrix associated with the signals in such a way that the first and second elements correspond to each other or are symmetric with respect to each other. The skew spectrum Es may be obtained from a difference between first and second spectrums E1 and E2, which are associated with of the first and second elements, respectively. The use of the skew spectrum Es makes it easy to obtain an asymmetric signal associated with the inspection pattern 130. In other words, the asymmetric signal containing information on misalignment or tilt of the inspection pattern 130 can be easily obtained using the skew spectrum Es, not only when the inspection pattern 130 is formed on a TEG region of the semiconductor substrate 100 or does not serve as a part of the semiconductor device but also when the inspection pattern 130 is formed on a cell region of the semiconductor substrate 100 or serves as a part of the semiconductor device.

Accordingly, an inspection method for a semiconductor device can be performed with high reliability. Further, it is possible to realize an inspection system capable of inspecting a semiconductor device with improved inspection reliability and fabricate a highly-reliable semiconductor device.

While exemplary embodiments have been particularly shown and described with reference to certain exemplary embodiments thereof, it will be understood by one of ordinary skill in the art that variations in form and detail may be made therein without departing from the spirit and scope of the exemplary embodiments.

1. A method of inspecting a semiconductor device, comprising:
measuring an inspection pattern formed on a semiconductor substrate using a measurer configured to measure optical signals reflected from the inspection pattern to obtain a signal expressed by a matrix including spectrum data associated with the inspection pattern,
obtaining a first element including a first spectrum from the signal and obtaining a second element including a second spectrum from the signal;
obtaining a skew spectrum using a difference between the first and second spectrums; and
obtaining an asymmetric signal associated with the inspection pattern using the skew spectrum;
wherein the obtaining of the asymmetric signal comprises:
obtaining a polarity of the skew spectrum in a wavelength range; and
obtaining a numerical value associated with an area of the skew spectrum.

2. The method of claim 1, wherein the measuring of the inspection pattern comprises:
measuring, using the measurer, the inspection pattern at a first azimuth to obtain a first signal; and
measuring, using the measurer, the inspection pattern at a second azimuth to obtain a second signal,
wherein the first and second azimuths are selected to have a difference of 180° from each other.

3. The method of claim 2, wherein the first element is obtained from the first signal, and the second element is obtained from the second signal.

4. The method of claim 3, wherein the first and second signals are respectively expressed by first and second Mueller matrices,
the first element is an element in an i-th row and a j-th column of the first Mueller matrix, and
the second element is an element in the i-th row and the j-th column of the second Mueller matrix, where i and j are integers.

5. The method of claim 4, wherein the first element is an off-diagonal element among off-diagonal elements in the first Mueller matrix, and the second element is an off-diagonal element among off-diagonal elements in the second Mueller matrix.

6. The method of claim 1, wherein the measuring of the inspection pattern comprises using a spectroscopic ellipsometer to measure the inspection pattern.

7. The method of claim 1, wherein the measuring of the inspection pattern comprises measuring the inspection pattern at a single azimuth using the measurer.

8. The method of claim 7, wherein:
the matrix is expressed as a Mueller matrix,
the first element is an element in an x-th row and a y-th column of the Mueller matrix, and
the second element is an element in the y-th row and the x-th column of the Mueller matrix, where x and y are integers.

9. The method of claim 8, wherein each of the first and second elements are off-diagonal elements among off-diagonal elements of the Mueller matrix.

10. The method of claim 1, wherein the inspection pattern comprises a lower pattern and an upper pattern sequentially stacked on the semiconductor substrate,
the asymmetric signal comprises information on misalignment between the lower and upper patterns,
the polarity of the skew spectrum is obtained to represent a misalignment direction of the upper pattern with respect to the lower pattern, and
the numerical value is obtained to represent a misalignment distance between the upper and lower patterns.

11. The method of claim 1, wherein, when viewed in a sectional view, the inspection pattern has a central axis,
the asymmetric signal comprises information on a tilt of the central axis with respect to a reference line that is normal to a top surface of the semiconductor substrate,
the polarity of the skew spectrum is obtained to represent a tilt direction of the central axis with respect to the reference line, and
the numerical value is obtained to represent a tilt angle of the central axis with respect to the reference line.

12. The method of claim 1, wherein the asymmetric signal comprises information on misalignment or tilt of the inspection pattern, and the polarity of the skew spectrum is obtained to represent a misalignment direction or a tilt direction,
wherein the obtaining of the polarity of the skew spectrum comprises assigning a first direction for the polarity of the skew spectrum, when the skew spectrum in the wavelength range has a positive value, and assigning a second direction antiparallel to the first direction for the polarity of the skew spectrum, when the skew spectrum in the wavelength range has a negative value,
wherein the first and second directions are associated with the misalignment direction or the tilt direction.

13. The method of claim 1, wherein the asymmetric signal comprises information on misalignment or tilt of the inspection pattern, and the numerical value is obtained to represent a misalignment distance or a tilt angle, and
wherein the obtaining of the numerical value comprises:
obtaining the area of the skew spectrum; and
obtaining the numerical value corresponding to the area of the skew spectrum, based on a correlation function that is prepared in advance to describe a correlation between the area of the skew spectrum and the numerical value associated therewith.

14. A semiconductor inspection system, comprising:
signal measurement equipment configured to measure an inspection pattern formed on a semiconductor substrate and obtain a signal expressed by a matrix including spectrum data associated with the inspection pattern; and
a controller configured to obtain first and second elements including first and second spectrums, respectively, from the signal, to obtain a skew spectrum using a difference between the first and second spectrums, and to obtain an asymmetric signal associated with the inspection pattern using the skew spectrum,
wherein the obtaining of the asymmetric signal comprises:
obtaining a polarity of the skew spectrum in a wavelength range; and
obtaining a numerical value associated with an area of the skew spectrum.

15. The system of claim 14, wherein the signal measurement equipment comprises a spectroscopic ellipsometer.

16. The system of claim 15, wherein the obtained signal comprises a first signal measured at a first azimuth and a second signal measured at a second azimuth, and the first and second azimuths are selected to have a difference of 180° from each other.

17. The system of claim 16, further comprising a memory device configured to store the first and second signals,
the first and second signals are respectively expressed by first and second Mueller matrices, and
the controller is configured to select elements in an i-th row and a j-th column of the first and second Mueller matrices as the first and second elements, respectively, where i and j are integers.

18-20. (canceled)

21. An inspection system, comprising:
a measurer configured to emit a signal to a pattern formed on a semiconductor substrate and measure the signal reflected from the pattern; and
a controller configured to determine a matrix corresponding to the measured signal, obtain a first element and a second element from the matrix, and determine whether the pattern is abnormal based on the first and second elements.

22. The inspection system of claim 21, wherein the first element corresponds to a first spectrum, the second element corresponds to a second spectrum, and the controller is configured to determine whether the pattern is abnormal based on a difference between the first and second spectrums.

23. The inspection system of claim 21, wherein the difference is proportional to a magnitude of an abnormality in the pattern.
